(19) United States
(12) Patent Application Publication
(10) Pub. No.: US 2006/0073293 A1
(43) Pub. Date: Apr. 6, 2006

(54) Finish assembly, preform assembly, container assembly, and method of manufacture

(76) Inventor: Thomas E. Nahill, Amherst, NH (US)

Correspondence Address: KUDIRKA & JOBSE, LLP, ONE STATE STREET, SUITE 800, BOSTON, MA, 02109, US

(21) Appl. No.: 10/958,616

(22) Filed: Oct. 4, 2004

(51) Int. Cl. B32B 27/08

(52) U.S. Cl. 428/35.7

(57) ABSTRACT

A method of producing a finish assembly, preform assembly, or container assembly, including placing a plastic finish ring over a neck of a plastic preform or container, and conjointly radially displacing a portion of the neck and a portion of the finish ring overlying the portion of the neck, such that the portions are nested one within another and prevent at least one of axial and circumferential movement of the finish ring on the neck.

The present invention is directed to finish assemblies for plastic containers or preforms, to preform assemblies for blow molding plastic container assemblies, to plastic container assemblies blow molded from such preform assemblies, and to methods of making such finish assemblies, preform assemblies, and container assemblies.

### BACKGROUND AND SUMMARY OF THE INVENTION

In the manufacture of plastic containers, it is conventional to injection mold or compression mold a container preform having a body and a neck finish with one or more external threads or other closure attachment means. The preform neck finish typically is molded to its final geometry, while the body of the preform subsequently is blow molded to the desired geometry of the container body. The preform may be of monolayer construction, or may be of multilayer construction in which one or more intermediate layers in the preform body may or may not extend into the finish area of the preform. U.S. Pat. Nos. 4,609,516, 4,710,118 and 4,954,376 illustrate injection molding of multilayer container preforms.

Molding the finish portion of the container as part of the preform presents a number of problems. For example, when the preforms are formed by injection molding, the plastic material typically is injected into a mold cavity at the closed end of the preform body, so that the material must flow along the sides of the preform cavity into the area in which the neck finish is molded. The finish typically requires more accurate and stable dimensioning than the body of the preform, which can limit the cycle time of the molding process. Furthermore, the finish portion of the preform is of the same material as at least the outer layers of the preform body, which limits the ability to obtain the most desirable characteristics at the finish. When the preform is of polyester construction, such as polyethylene terephthalate (PET), the finish portion of the preform can be wholly or partially crystallized to improve the operating characteristics of the finish area, particularly in hot-fill container applications. However, the requirement that the finish be of the same material as at least the outer layers of the preform body (in a multilayer preform) still limits the design capabilities of preform manufacture.

A method of attaching a plastic finish ring to a plastic preform or container neck is provided in accordance with one aspect of the invention and includes steps of: placing a plastic finish ring over a neck of a plastic preform or container, and conjointly radially displacing a portion of the neck and a portion of the finish ring overlying the portion of the neck, such that the portions are nested one within another and prevent at least one of axial and circumferential movement of the finish ring on the neck.

In accordance with a second aspect of the invention, there is provided a finish assembly on a plastic preform or container. The finish assembly includes a cylindrical neck of plastic material, and an annular finish ring externally surrounding the neck. The finish ring and neck include radially aligned portions of limited angular dimension that are displaced radially inwardly to attach the finish ring to the neck.

In accordance with a third aspect of the invention, there is provided a finish assembly on a plastic preform or container, which includes a cylindrical neck of plastic material having a radial thickness and at least one interengagement portion of the radial thickness, and further includes an annular finish ring externally encircling the neck. The finish ring has at least one interengagement portion that extends into the at least one interengagement portion on the neck to attach the finish ring to the neck.

In accordance with a fourth aspect of the invention, a preform assembly for blow molding a plastic container is provided and includes a plastic preform and a finish ring. The plastic preform has a body with a closed end and a neck integrally extending from the body, wherein the neck includes at least one interengagement portion therein. The finish ring has an annular body externally surrounding the neck of the plastic preform. The finish ring further has at least one external thread and at least one interengagement portion being in registration with the at least one interengagement portion of the plastic preform.

In accordance with a fifth aspect of the invention, a container assembly includes a plastic container and a finish ring. The plastic container has a body with a closed end and a neck integrally extending from the body, wherein the neck has at least one interengagement portion therein. The finish ring has an annular body externally surrounding the neck of the plastic container. The finish ring further has at least one external thread and at least one interengagement portion being in registration with the at least one interengagement portion of the plastic preform.

### BRIEF DESCRIPTION OF THE DRAWINGS

The invention, together with additional objects, features, advantages and aspects thereof, will be best understood from the following description, the appended claims and the accompanying drawings, in which:

FIG. 1 is an elevational view of a fastened preform assembly according to one exemplary embodiment of the present invention;

FIG. 2 is an exploded elevational view of an unfastened preform assembly according to an exemplary embodiment of the present invention, showing a preform and a finish ring;

FIG. 3 is a cross-sectional view of the preform assembly of FIG. 1, taken substantially along line 3-3;

FIG. 4 is a perspective schematic diagram illustrating a method of fastening the unfastened preform assembly of FIG. 2, according to another exemplary embodiment of the present invention; and

FIG. 5 is an exploded perspective view of a fastened container assembly according to still another exemplary embodiment of the present invention.

### DETAILED DESCRIPTION OF PREFERRED EMBODIMENTS

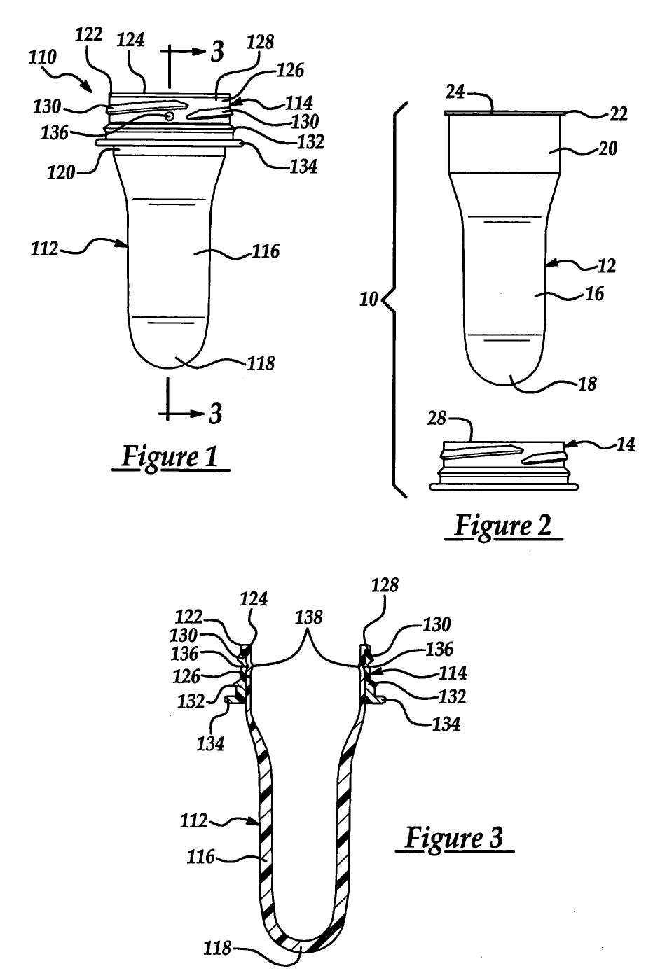

FIGS. 1 and 3 illustrate a preform assembly 110 in accordance with a presently preferred embodiment of the invention as including a preform 112 and a finish ring 114 assembled thereto so as to externally surround or encircle a portion of the preform 112. The preform 112 includes a body 116 with a closed end 118 and an integrally formed neck 120 having an annular flange 122 extending radially outwardly at an open end 124 of the preform 112. The neck 120 of the preform 112 and the finish ring 114 together define a finish assembly. The neck 120 is preferably of cylindrical construction, and the flange 122 is preferably circumferentially continuous and substantially perpendicular to the longitudinal axis of the neck 120. The preform 112 is preferably of compression or injection molded plastic construction and is composed of any suitable plastic material such as monolayer polyethylene terephthalate (PET) or multilayer PET alternated with layers of a barrier resin material such as ethylene vinyl alcohol (EVOH), nylon, or the like.

Still referring to FIGS. 1 and 3, the finish ring 114 is preferably of molded plastic construction, having an annular body 126 that axially terminates in an open end 128 that axially abuts the flange 122 of the preform 112. The annular body 126 also includes at least one external thread 130, bead, or the like for securing a closure (not shown) thereto, an annular bead 132 for engagement by tamper-indicating means on the closure, and an annular support flange 134 for material handling purposes.

As best shown in the cross-sectional illustration of FIG. 3, the annular body 126 of the finish ring 114 includes interengagement portions, pawls or projections 136 that engage, register or nest within corresponding interengagement portions, detents or pockets 138 of the preform 112. The interengagement portions are radially aligned, are of substantially the same radial wall thickness as surrounding portions of material, and are of limited angular dimension. The interengagement, or radially aligned, portions 136, 138 provide a simple means by which the finish ring 114 may be fastened to the preform 112 so as to prevent rotation and relative axial displacement therebetween. The interengagement portions 136, 138 are formed into the preform assembly 110, i.e. after the finish ring 114 is assembled to the preform 112, as will be discussed in further detail below. Although the interengagement portions 136, 138 are depicted as extending in a radially inwardly direction, the present invention contemplates that the interengagement portions 136, 138 could instead extend in a radially outward direction. The finish ring 114 is preferably injection or compression molded, and is composed of any desired material such as PET, post consumer resin (PCR), process regrind (REG), polypropylene (PP), polyethylene (PE), polyethylene napthalate (PEN), or the like. Where the finish ring 114 is of polyester construction (e.g. PET, PEN, or REG), the finish ring 114 may be wholly or partially crystallized as molded. This may be accomplished by employing fast-crystallizing materials or suitably setting process conditions for manufacture of the finish ring, such as high mold temperature, slow mold cooling, heated areas in the mold cavity, etc. Alternatively, the finish ring may be crystallized in a post-molding operation.

Referring now to FIGS. 2 and 4, a method according to an exemplary embodiment of the present invention will now be discussed. In FIG. 2, there is shown an unfastened preform assembly 10 in exploded view. The preform assembly 10 is substantially similar to that of FIGS. 1 and 3, with the exception that the interengagement features are not yet formed. The preform assembly 10 includes a finish ring 14 assembled or positioned over a neck portion 20 of a preform 12. The finish ring 14 is axially assembled over a closed end 18, body 16, and the neck portion 20 of the preform 12, until an open end 24 thereof axially abuts a flange 22 extending from the neck portion 20 of the preform 12. The finish ring 14 may have an inner diameter that is slightly smaller than an outer diameter of the neck portion 20 of the preform 12 so as to create an interference fit therebetween.

Referring to FIG. 4, once the finish ring 14 is assembled to the neck portion 20 of the preform 12, a staking process is undertaken to deform portions of the preform assembly 10 to create the interengagement portions discussed previously with respect to FIGS. 1 and 3, and thereby secure the finish ring 14 to the preform 12 against rotation or axial displacement. Here, a tool and die apparatus A is used to create the interengagement portions. A tool, punch or pin P is oriented in a radial position with respect to the finish assembly. Then, a die, plug or mandrel M is inserted into the open end 24 of the preform 12 and includes an axially extending void or channel C in a circumferentially external surface S, wherein the mandrel M is circumferentially oriented with respect to the pin P such that the channel C aligns with the pin P for cooperation therewith. Just before staking takes place, the walls of the preform 12 and finish ring 14 are interposed between the pin P and the mandrel M. (As shown, however, the pin P and mandrel M are positioned just axially outside of the preform assembly 10.) During staking, the pin P is driven toward the channel C of the mandrel M so as to conjointly radially displace portions of the walls of the preform 12 and finish ring 14 so as to create the interengagement portions thereof. As such, the interengagement portions become nested one within another and thereby prevent axial or circumferential movement between the finish ring 14 and preform 12.

Thereafter, the pin P and mandrel M are withdrawn, wherein the axial channel C is open at one end thereof to provide clearance for retracting the mandrel M without interference with the newly formed interengaging features. The pin P and the channel C are sized with axial and lateral clearance therebetween such that the radial wall thicknesses of the preform 12 and finish ring 14 can be substantially retained, thereby avoiding puncture or thinning thereof. Staking may be performed at one or more positions around the finish assembly, including diametrically opposed positions as illustrated in sectional view FIG. 3. To create more than one set of interengagement portions, the preform assembly 10 may be rotated and the staking process repeated or multiple pins may be simultaneously actuated against a mandrel having multiple cavities. Moreover, any other type of tooling setup may be used to deform the material of the preform assembly to create the interengagement portions and may involve either cold forming or heated tooling processes. For example, other tooling could be used so as to create interengagement portions that instead extend in a radially outwardly direction. Finally, although it is preferred to assemble the finish ring 14 to the preform 12 prior to blow molding the preform body 16 into a container body, it is within the broadest aspects of the present invention to assemble the finish ring 14 after the preform body 16 has been blown.

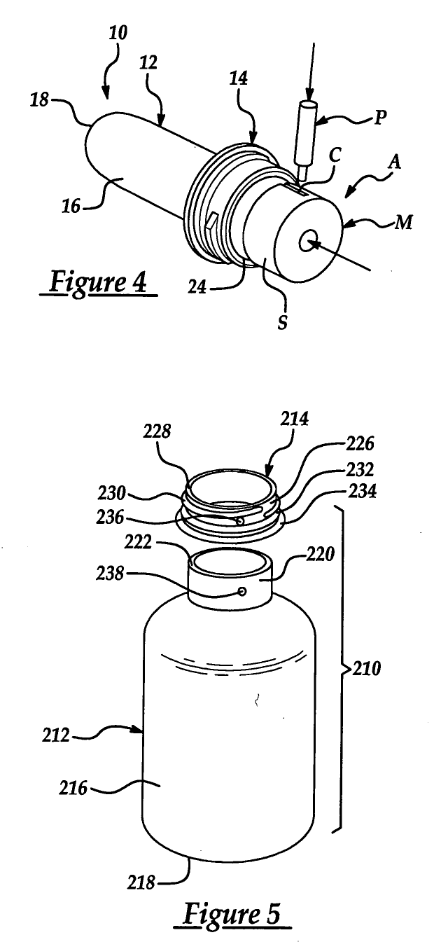

Therefore, and referring now to FIG. 5, there is illustrated an exploded perspective view of a container assembly 210 according to another exemplary embodiment of the present invention. The container assembly 210 includes a container 212 and a finish ring 214 assembled thereto so as to externally surround or encircle a portion of the container 212. The container 212 includes a body 216 with a closed end 218 and an integrally formed neck 220 terminating in an open end 124 of the container 212. The neck 220 of the container 212 and the finish ring 214 together define a finish assembly. The container 212 is preferably of blow molded plastic construction and is composed of any suitable plastic material such as monolayer polyethylene terephthalate (PET) or multilayer PET alternated with layers of a barrier resin material such as ethylene vinyl alcohol (EVOH), nylon, or the like.

Still referring to FIG. 5, the finish ring 214 is preferably of molded plastic construction, having an annular body 226 that axially terminates in an open end 228. The annular body 226 also includes at least one external thread 230, bead, or the like for securing a closure (not shown) thereto, an annular bead 232 for engagement by tamper-indicating means on the closure, and an annular support flange 234 for material handling purposes. The finish ring 214 is preferably injection or compression molded and is composed of any desired material such as PET, post consumer resin (PCR), process regrind (REG), polypropylene (PP), polyethylene (PE), polyethylene napthalate (PEN), or the like.

The annular body 226 of the finish ring 214 includes one or more interengagement portions, pawls, or projections 236 that engage, register, or nest within corresponding interengagement portions, detents, or pockets 238 of the container 212. The interengagement, or radially aligned, portions 236, 238 provide a simple means by which the finish ring 214 may be fastened to the container 212 so as to prevent rotation and relative axial displacement therebetween. The interengagement portions 236, 238 are formed into the container assembly 210, i.e. after the finish ring 214 is assembled to the container 212, as was discussed in detail above with respect to FIGS. 1 through 4. The method of manufacturing the container assembly is identical to that described above, with the exception that the finish ring 214 is assembled over the open end 222 of the container 212 rather than over the closed end 218. Although the container 212 as shown does not include an annular flange at the open end 222 thereof, it is contemplated that the method of manufacturing the container assembly could further include a step of swaging a portion of the container 212 at the open end 222 thereof, after the finish ring 214 has been assembled thereover, thereby creating an annular sealing flange.

With all of the embodiments described above, it is evident that the present invention provides anti-rotation interengaging features in a finish assembly to eliminate the difficulties associated with creating finish assemblies that are comprised of separate components having pre-formed interengaging features. Also, the material and conditions of fabricating the finish ring may be selected separately from the material and manufacturing conditions of the preform to achieve desired operating characteristics of the finish assembly. Moreover, the preform can be molded with thin wall sections without having to accommodate flow of molten material into a thicker finish area, which reduces material cost and mold cycle time.

There have thus been described finish assemblies for plastic containers or preforms, preform assemblies for blow molding plastic container assemblies, plastic container assemblies blow molded from such preform assemblies, and methods of making such finish assemblies, preform assemblies, and container assemblies that fully satisfy all of the objects and aims previously set forth. The present invention has been disclosed in conjunction with presently preferred embodiments thereof, and a number of modifications and variations have been discussed. Other modifications and variations will readily suggest themselves to persons of ordinary skill in the art in view of the foregoing description. Indeed, the invention is intended to embrace all modifications and variations as fall within the spirit and broad scope of the appended claims.

1. A method of attaching a plastic finish ring to a plastic preform or container neck, which includes the steps of:
(a) placing a plastic finish ring over a neck of a plastic preform or container, and
(b) conjointly radially displacing a portion of said neck and a portion of said finish ring overlying said portion of said neck, such that said portions are nested one within another and prevent at least one of axial and circumferential movement of said finish ring on said neck.

2. The method set forth in claim 1 wherein said step (b) is accomplished while retaining radial thicknesses of said portions.

3. The method set forth in claim 1 wherein said step (b) is accomplished by: (b1) locating a mandrel within said neck, said mandrel having at least one axial channel on an external surface of said mandrel, (b2) engaging a pin against one external portion of said finish ring radially aligned with said channel, (b3) employing said pin to displace said portions radially into said channel, and (b4) withdrawing said mandrel from said neck, with said channel providing clearance as said mandrel is withdrawn over the displaced portions of said neck.

4. The method set forth in claim 1 wherein step (a) is accomplished by pressing said finish ring to said neck under an interference fit condition.

5. The method as set forth in claim 1 wherein said finish ring is composed of a material different from that of said preform.

6. The method as set forth in claim 5 wherein said finish ring is composed of material selected from the group consisting of PET, PP, PE, PEN, REG, and PCR.

7. An article produced by the method of claim 1.

8. A finish assembly on a plastic preform or container, said finish assembly including:
a cylindrical neck of plastic material, and
an annular finish ring externally surrounding said neck,
radially aligned portions of said finish ring and said neck of limited angular dimension being displaced radially inwardly to attach said finish ring to said neck.

9. The finish assembly set forth in claim 8 wherein said finish ring is interference fit to said neck.

10. The finish assembly as set forth in claim 8 wherein said finish ring is composed of a material different from that of said neck.

11. The finish assembly as set forth in claim 10 wherein said finish ring is composed of material selected from the group consisting of PET, PP, PE, PEN, REG, and PCR.

12. A finish assembly on a plastic preform or container, which includes:
a cylindrical neck of plastic material having a radial thickness and at least one interengagement portion of said radial thickness, and
an annular finish ring externally encircling said neck, said finish ring having at least one interengagement portion that extends into said at least one interengagement portion on said neck to attach said finish ring to said neck.

13. The finish assembly set forth in claim 12 wherein said finish ring is interference fit to said neck.

14. The finish assembly as set forth in claim 12 wherein said finish ring is composed of a material different from that of said neck.

15. The finish assembly as set forth in claim 14 wherein said finish ring is composed of material selected from the group consisting of PET, PP, PE, PEN, REG, and PCR.

16. A preform assembly for blow molding to form a plastic container, which includes:
a plastic preform having a body with a closed end and a neck integrally extending from said body, said neck having at least one interengagement portion therein, and
a finish ring having an annular body externally surrounding said neck of said plastic preform, said finish ring further having at least one external thread and at least one interengagement portion being in registration with said at least one interengagement portion of said plastic preform.

17. The finish assembly set forth in claim 16 wherein said finish ring is interference fit to said neck.

18. The finish assembly as set forth in claim 16 wherein said finish ring is composed of a material different from that of said preform.

19. The finish assembly as set forth in claim 18 wherein said finish ring is composed of material selected from the group consisting of PET, PP, PE, PEN, REG, and PCR.

20. A container assembly which includes:
a plastic container having a body with a closed end and a neck integrally extending from said body, said neck having at least one interengagement portion therein, and
a finish ring having an annular body externally surrounding said neck of said plastic container, said finish ring further having at least one external thread and at least one interengagement portion being in registration with said at least one interengagement portion of said plastic preform.

21. The finish assembly set forth in claim 20 wherein said finish ring is interference fit to said neck.

22. The finish assembly as set forth in claim 20 wherein said finish ring is composed of a material different from that of said preform.

23. The finish assembly as set forth in claim 22 wherein said finish ring is composed of material selected from the group consisting of PET, PP, PE, PEN, REG, and PCR.
